(19) United States
(12) Patent Application Publication
(10) Pub. No.: US 2022/0306494 A1
(43) Pub. Date: Sep. 29, 2022

(54) SYSTEMS AND APPARATUSES FOR TREATING WATER

(71) Applicant: M.A.R.S. BIO-MED PROCESSES INC., Whitby (CA)

(72) Inventor: Michael James Darcy, Bowmanville (CA)

(21) Appl. No.: 17/616,956

(22) PCT Filed: Jun. 5, 2020
(86) PCT No.: PCT/IB2020/055336

§ 371 Date: Dec. 6, 2021

Related U.S. Application Data
(60) Provisional application No. 62/857,981, filed on Jun. 6, 2019.
(60) Provisional application No. 62/911,510, filed on Oct. 7, 2019.

(51) Int. Cl. C02F 1/42; C02F 1/28; C02F 1/62

(52) U.S. Cl. CPC C02F 1/42; C02F 1/285; C02F 1/62; C02F 2101/20

(57) ABSTRACT

An example water treatment apparatus includes: a housing having an inlet to receive water containing a contaminant; a primary treatment compartment within the housing, the primary treatment compartment including a primary media bed containing a ion exchange media to separate the contaminant from the water, the primary media bed supported above a collection area of the primary treatment compartment; and a conduit to direct flow of the water to the collection area; and wherein overflow of the water in the collection area is directed against gravity through the primary media bed to produce treated water.

### FIELD

The specification relates generally to water systems, and more particularly to systems and apparatuses for treating water.

### BACKGROUND

Water is used in many cleaning applications and may collect contaminants. Treatment systems, such as screens, media beds, and the like, may be used to treat the water to separate the contaminant, including solid materials, such as dirt, plastics, metals, and soluble materials, such as soluble metals from the contaminated water.

### SUMMARY

According to an aspect of the present specification, a water treatment apparatus is provided. The water treatment apparatus includes: a housing having an inlet to receive water containing a contaminant; a primary treatment compartment within the housing, the primary compartment including a primary media bed containing a ion exchange media to separate the contaminant from the water, the primary media bed extending across the primary treatment compartment to define a collection area of the primary treatment compartment; and a conduit to direct flow of the water to the collection area; and wherein overflow of the water in the collection area is directed against gravity through the primary media bed to produce treated water.

According to another aspect of the present specification, another water treatment apparatus is provided. The water treatment apparatus includes a housing having an inlet to receive water containing a contaminant, the housing having a treatment space; a separating wall extending from a floor of the housing to divide the treatment space into a primary treatment compartment and a secondary treatment compartment; a primary media bed containing a ion exchange media to separate the contaminant from the water in the primary treatment compartment; and a secondary media bed containing a further ion exchange media to separate the contaminant from the water in the secondary treatment compartment.

According to another aspect of the present specification, a water treatment system for treating water containing soluble mercury is provided. The water treatment system includes: a water treatment apparatus comprising: a housing having an inlet to receive the water; and a media bed disposed in the housing, the media bed extending across a treatment space of the housing to divide the treatment space into a collection area and an outflow area and containing a ion exchange media to separate the soluble mercury from the water to produce treated water, wherein the collection area is fluidly coupled to the inlet to receive the water from the inlet; and wherein the water in the collection area is directed against gravity through the media bed to the outflow area to produce the treated water.

According to another aspect of the present specification, a method of treating water is provided. The method includes: receiving water to be treated; separating solid material from the water; accumulating the water in a collection area; directing overflow from the collection area through a media bed against gravity; the media bed containing a ion exchange media to separate a contaminant from the water; and outputting treated water.

### BRIEF DESCRIPTION OF DRAWINGS

Implementations are described with reference to the following figures, in which:

FIG. 1A depicts an example water treatment apparatus;

FIG. 1B depicts a cross section of a primary media bed in the water treatment apparatus of FIG. 1A;

FIG. 2 depicts another example water treatment apparatus;

FIG. 3 depicts a schematic diagram of the flow of water in the water treatment apparatus of FIG. 2;

FIG. 4 depicts an example water treatment system; and

FIG. 5 depicts an example method of treating water.

### DETAILED DESCRIPTION

Water is used in many cleaning applications and collects contaminants, such as dirt, plastics, metals, polymers, and the like. In particular applications, health regulations may require that such wastewater be treated to remove said contaminants prior to discharging the water back into a main water stream. For example, in the dental industry, dental waste streams often includes amalgam, including soluble mercury and other metallic compounds. Amalgam separators or scrubbers may separate the amalgam from the water prior to discharging the water into public wastewater streams. For example, some governmental jurisdictions may require that 99 percent by weight of dental amalgam be removed from dental wastewater flow prior to discharge to public sewers.

An example water treatment apparatus includes a housing and a treatment compartment within the housing configured to improve the efficacy of the treatment process. In particular, the water treatment apparatus includes a conduit to direct the water to be treated to a collection area. Water in the collection area is accumulated until it overflows through a media bed to produce at least partially treated water. In particular, by accumulating water in the collection area to cause the water level to overflow through the media bed, the ion exchange period (i.e., the time taken for water to pass through the media bed) is increased, thereby increasing the ability of the ion exchange media in the media bed to separate contaminant from the water. Further, the water treatment apparatus may employ a deeper media bed to further increase the ion exchange period, as well as increasing the amount of ion exchange media available to separate the contaminant from the water.

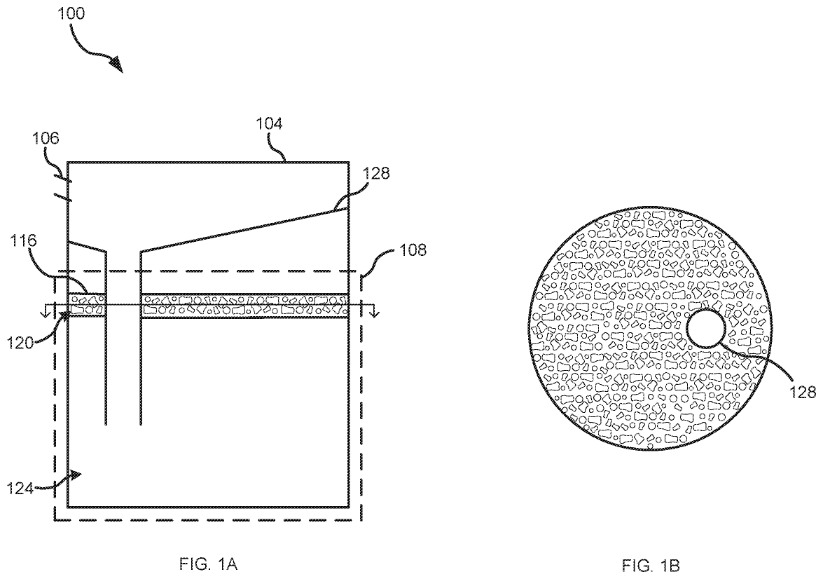

FIG. 1A depicts a water treatment apparatus 100 in accordance with the present specification. The water treatment apparatus 100 (also referred to herein as simply the apparatus 100) is generally to treat water containing a contaminant to produce treated water from which the contaminant has been separated. The water treatment apparatus 100 includes a housing 104, a primary treatment compartment 108 within the housing 104 to treat the water and a conduit 112 disposed in the housing 104 to direct the flow of the water within the housing 104. Preferably, the water treatment apparatus 100 is compact and portable for transporting between locations (e.g., for installation at a site or disposal) or repositioning but may remain substantially stationary during use. For example, the water treatment apparatus 100 may be between about 13 to 36 inches in diameter, between about 21 to 48 inches in height. In other examples, the water treatment apparatus 100 may be between about 6 to 8 inches in diameter, and between about 12 to 18 inches in height.

The housing 104 defines an enclosed space for treating the water, and preferably is impermeable to vapors and liquids. The housing 104 includes an inlet 106 to receive the water to be treated (i.e., containing a contaminant) and may include an outlet (not shown) to output the treated water. The housing 104 may be integrally formed or may include a base portion and a lid for maintaining or disposing of the interior components of the water treatment apparatus 100.

The primary treatment compartment 108 is disposed within the housing and is a compartment or a space within the water treatment apparatus 100 where at least a portion of the treatment process occurs. In some examples, the water treatment apparatus 100 may include a series of treatment compartments (not shown) for multiple treatment steps. The primary treatment compartment 108 includes a primary media bed 116 containing a ion exchange media 120 to separate the contaminant from the water. The primary media bed 116 may be a mesh structure formed of, for example, metal, plastic, polymers, fabrics, or other suitable materials to support and/or enclose the ion exchange media 120 while allowing the water to pass through the primary media bed 116, For example, the primary media bed 116 may include a bag enclosing the ion exchange media 120. The primary media bed 116, in turn, may be supported in a sleeve or bucket structure in the housing 104.

The ion exchange media 120 is generally to separate the contaminant from the water. For example, the ion exchange media 120 may be a micro-porous material impervious to water. In particular, the ion exchange media 120 is micro-porous to accept and retain a large number of contaminant particles. Further, the ion exchange media 120 is impervious or substantially impervious to water to reduce the amount of water-based erosion or degradation of the ion exchange media 120. That is, the stability of the ion exchange media 120 in water extends the longevity of the water treatment apparatus 100 and improves the retention of contaminant particles in the ion exchange media 120.

In some examples, the ion exchange media 120 may be ionized to attract and retain oppositely charged contaminant particles. For example, the ion exchange media 120 may comprise activated coconut carbon to separate soluble mercury from the water via ion exchange. In other examples, the ion exchange media 120 may be selected according to the particular contaminant or contaminants to be separated from the water. For example, the ion exchange media 120 may be selected to have pores based on the contaminant particle size. Further, the ion exchange media 120 may be selected based on the capacity of the ion exchange media 120 to attract (e.g., by ionization, by other chemical or physical properties) and retain the contaminant particles.

The primary media bed 116 is supported above a collection area 124 of the primary treatment compartment 108. For example, as depicted in the present example, the primary media bed 116 may be supported near the top of the primary treatment compartment 108 with the collection area 124 defined below the primary media bed 116.

The conduit 112 is to direct flow of water within the housing 104 to at least partially effect the treatment process described herein. In particular, the conduit 112 directs the flow of water from the inlet 106 to the collection area 124. As depicted in FIG. 1B, the primary media bed 116 may be arranged around the conduit 112 to allow water from the inlet 106 to flow directly to the collection area 124.

The collection area 124 is to receive and collect water received from the inlet 106. The collection area 124 may collect water until overflow of water in the collection area 124 is directed against gravity through an overflow region 136 of the primary media bed 116 to produce treated water.

The collection of water in the collection area 124 serves multiple purposes to improve the efficacy of treatment of the water. First, the collection area 124 may act as a settling or sedimentation chamber. That is, the collection area 124 provides a relatively large volume in which water is accumulated, and hence may take time to fill, relative to the rate of inflow of water at the inlet 106, While water is collected in the collection area 124, the density of solid particles causes them to sink to the bottom of the collection area 124. The collection area 124 thus allows for sedimentation of solid particles from the water as a step of the water treatment process.

Second, the direction of overflow from the collection area against gravity through the primary media bed 116. In particular, the rate at which the water level in the collection area 124 rises and overflows through the primary media bed 116 increases the ion exchange period (i.e., time spent for water to pass through the primary media bed 116). The longer ion exchange period of the water in the primary media bed 116 in turn allows a higher efficacy of the ion exchange media 120 to separate the contaminant from the water.

The water treatment apparatus 100 thus allows for an improved treatment efficacy of contaminants in a water stream, by both sedimentation of solid materials from the water, as well as ion exchange to remove soluble contaminants. The water treatment apparatus 100 may be utilized, for example, to separate soluble mercury and/or other metals from a dental waste stream.

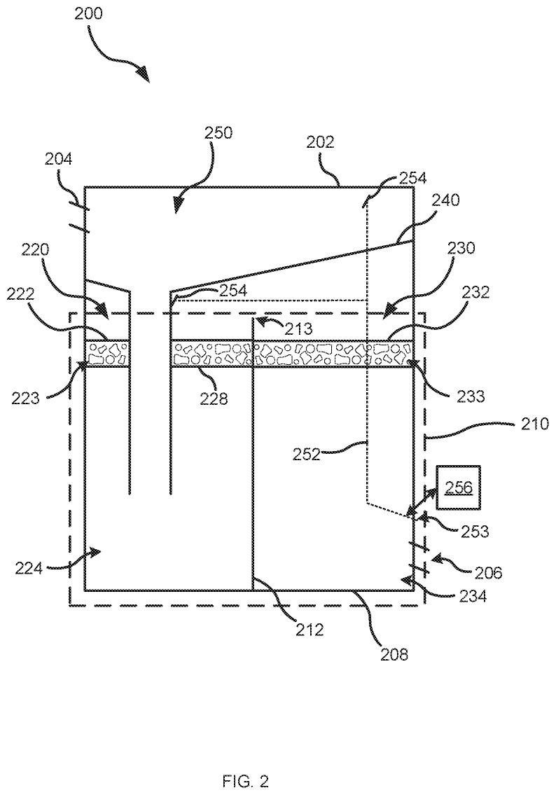

FIG. 2 depicts another example water treatment apparatus 200 configured to treat water containing a contaminant to produce treated water from which the contaminant (or a substantial percentage of the contaminant) has been separated. The water treatment apparatus 200 is similar to the water treatment apparatus 100. Preferably, the water treatment apparatus 200 is similarly compact and portable for transporting between locations (e.g., for installation at a site or disposal/removal from a site) or repositioning. For example, the water treatment apparatus 200 may be between about 13 to 36 inches in diameter, between about 21 to 48 inches in height. In other examples, the water treatment apparatus 200 may be between about 6 to 8 inches in diameter, and between about 12 to 18 inches in height.

The water treatment apparatus 200 includes a housing 202 defining an enclosed space for treating the water. Preferably, the housing 202 may be formed of a durable material, such as plastics, metals, combinations of the above, and/or other materials which are suitable for housing water. Further, the housing 202 is preferably vapor impermeable, to reduce leakage of odors or hazardous gases produced during the treatment process. The housing 104 may be integrally formed or may include a base portion and a lid for maintaining or disposing of the interior components of the water treatment apparatus 200. The housing 202 includes an inlet 204 to receive the water containing a contaminant and an outlet 206 to output treated water.

The housing 202 further defines a treatment space 210 within the water treatment apparatus 200, the treatment space 210 being a space within the housing 202 in which the treatment process occurs. The water treatment apparatus 200 further includes a separating wall 212 extending from a floor 208 of the housing 202 to divide the treatment space 210 into a primary treatment compartment 220 and a secondary treatment compartment 230. The separating wall 212 is generally configured to fluidly isolate the primary treatment compartment 220 and the secondary treatment compartment 230 (i.e., to prevent fluids from flowing freely between the primary and secondary treatment compartments 220-1, 220-2), except at designated areas. For example, in the present example, fluids may flow from the primary treatment compartment 220 to the secondary treatment compartment 230 by overflowing over a top edge 213 of the separating wall 212, as will be described further herein. The separating wall 212 may be integral with the housing 202, and in some examples, may physically divide the housing 202 such that the primary treatment compartment 220 and the secondary treatment compartment 230 form two legs of the housing 202. That is, the floor 208 may be formed of two spatially separated regions; one corresponding to the primary treatment compartment 220 and one corresponding to the secondary treatment compartment 230.

Each treatment compartment 220, 230 is configured for a treatment step of the treatment process. That is, the water is treated a first time in the primary treatment compartment 220, and the partially treated water from the primary treatment compartment 220 is treated a second time in the secondary treatment compartment 230. In some examples, the water treatment apparatus 200 may include further treatment compartments 220 for further treatment steps.

The primary treatment compartment 220 houses a primary media bed 222 containing a ion exchange media 223. The ion exchange media 223 is to separate the contaminant from the water; that is, the ion exchange media 223 is to treat the water via ion exchange in the primary treatment compartment 220. The primary media bed 222 may be a mesh-type structure formed of, for example, metals, plastics, polymers, fabrics, combinations, or other suitable materials to support or enclose the ion exchange media 223 while allowing the water to pass through the primary media bed 222. For example, the primary media bed 222 may include a bag enclosing the ion exchange media 223, The primary media bed 222 may, in turn, be supported on a sleeve or bucket structure supported on the walls of the housing 202. In particular, the sleeve may have a complementary shape to the housing 202 and be configured to slot into the interior of the housing 202

The secondary treatment compartment 230 houses a secondary media bed 232 containing a further ion exchange media 233. The further ion exchange media 233 is also to separate the contaminant from the water; that is, the ion exchange media 233 is to treat the water via ion exchange in the secondary treatment compartment 230. The secondary media bed 232 is similar to the primary media bed 222 and supports or encloses the ion exchange media 233 while allowing the water to pass through the secondary media bed 232.

The ion exchange media 223, 233 are generally to separate the contaminant from the water. Each of ion exchange media 223, 233 may include a single material or may include a combination of materials. Preferably, the ion exchange media 223 includes the same material as the ion exchange media 233 to enhance the efficacy of separating the desired contaminant from the water. In other examples, the ion exchange media 223 and 233 may be formed of different types of ion exchange materials. Further, in other examples, the ion exchange media 223, 233 may be to separate different types of contaminants from the water. The ion exchange media 223, 233 are preferably micro-porous materials impervious to water. In particular, the ion exchange media 223, 233 are micro-porous to accept and retain contaminant particles. Further, the ion exchange media 223, 233 is impervious or substantially impervious to water to reduce the amount of water-based erosion or degradation of the ion exchange media 223, 233. In some examples, the ion exchange media 223, 233 may be ionized to attract and retain oppositely charged contaminant particles.

For example, the ion exchange media 223, 233 may comprise activated coconut carbon to remove soluble mercury from the water via ion exchange. In particular, coconut carbon is micro-porous and activation, for example by steam, also serves to enhance the adsorption properties of the coconut carbon. In other examples, other activation mechanisms are also contemplated. Additionally, activated coconut carbon is ionized so as to attract and retain soluble mercury in its pores. Activated coconut carbon is also substantially impervious to water, and hence does not erode or degrade to release the mercury held therein. The water treatment apparatus 100 may be configured to contain about 2 to 3 pounds of activated coconut carbon between the media beds 222, 232. In particular, the primary media bed 222 may contain about 1.5 to 2 pounds of activated coconut carbon, while the secondary media bed 232 may contain about 0.5 to 1 pound of activated coconut carbon. In particular, to accommodate the larger amount of ion exchange media 223, the primary media bed 222 have a greater height (i.e., within the primary treatment compartment 220). The greater height of the primary media bed 222 may further serve to increase the ion exchange period of the primary media bed 222, as will be described further below.

In other examples, other quantities of ion exchange media 223, 233, and ratios of ion exchange media 223, 233 in the primary and secondary media beds 222, 232 are contemplated. Further, in other examples, other ion exchange media may be used. For example, the ion exchange media 223, 233 may be selected according to the particular contaminants to be separated from the water. For example, the ion exchange media 223, 233 may be selected to have pores based on contaminant particle size. Further, the ion exchange media 223, 233 may be selected based on the capacity of the ion exchange media 223, 233 to attract (e.g., by ionization, by other chemical or physical properties, or the like) and retain the contaminant particles.

In some examples, the primary media bed 222 may be supported above a collection area 224 of the primary treatment compartment 220. For example, as depicted in FIG. 2, the primary media bed 222 may is supported near the top of the primary treatment compartment 220 with the collection area 224 defined below the primary media bed 222. The collection area 224 is to receive and collect water received at the inlet 204. In particular, the water treatment apparatus 200 may further include a conduit 240 to direct flow of the water from the inlet 204 to the collection area 224. In particular, the inlet 204, the conduit 240, the primary media bed 222 and the collection area 224 are structured such that the flow of water from the inlet 204 along the conduit 240 to the collection area 224 is driven by gravity (i.e., the water flows with gravity). That is, the inlet 204 is above collection area 224. The primary media bed 222 may be arranged around the conduit 240 above the collection area 224 to allow water from the inlet 204 to flow directly to the collection area 224.

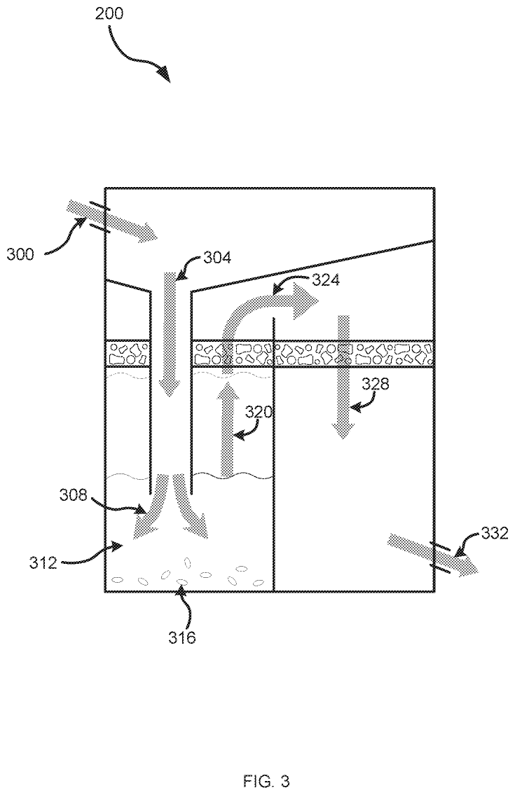

For example, referring to FIG. 3, a schematic diagram of the flow of water during the treatment process is depicted. Water is first received at the inlet 204, as depicted by arrow 300. The water is then directed by the conduit 240, at 304, through the primary media bed 222 to the collection area 224.

Returning to FIG. 2, the collection area 224 is to collect and accumulate water until overflow of water in the collection area 224 is directed against gravity through the primary media bed 222. As water is received in the water treatment apparatus 200, it is collected in the collection area 224, causing the water level in the collection area 224 to rise. When the collection area 224 reaches its volumetric capacity, additional water received at the inlet 204 causes the water in the collection area 224 to overflow and be directed through the primary media bed 222. The water therefore passes through the primary media bed 222 in a direction against gravity.

The configuration of the primary media bed 222, the conduit 240, and the collection area 224 serves to improve the efficacy of the water treatment apparatus 200. Specifically, water is directed through the primary media bed 222 in a direction against gravity, from the collection area 224 to overflow through the primary media bed 222. Further, the ion exchange period (i.e., time spent within the primary media bed 222) may be extended based on the rate at which the water level in the collection area rises and overflows through the primary media bed 222. The longer ion exchange period, including, by the increased depth or height of the primary media bed 222, allows the water to spend more time in the ion exchange media 223 to allow the ion exchange media 223 to separate the contaminant from the water.

In some examples, the conduit 240 may include a one-way valve (not shown), such as a ball valve, to allow the flow of water from the conduit 240 to the collection area 224 while restricting backflow into the conduit 240 as the water level in the collection area 224 rises. In further examples, the water treatment apparatus 200 may further include a pump or the like configured to drive the water through the conduit 240 into the collection area 224 so that water is accumulated in the collection area 224 rather than the conduit 240.

The collection area 224 may additionally act as a settling or sedimentation chamber for solid materials in the water. In particular, the collection area 224 provides a relatively large volume in which water is accumulated. While water is retained in the collection area 224, the density of solid particles causes them to sink to the bottom of the collection area 224. The water that is directed up through overflow region 228 of the primary media bed 222 is thus substantially free of solid particles. The collection area 124 thus allows for sedimentation of solid particles from the water as a step in the water treatment process.

Referring again to FIG. 3, the water exits the conduit 240 into the collection area 224 at 308 and adds to the volume of water 312 in the collection area 224, While the water is retained in the collection area 224, solid particles 316 may settle at the bottom of the collection area 224. As more water is added to the collection area 224, the water level in the collection area 224 rises at 320, until it overflows through the primary media bed 222 and over the top edge 213 of the separating wall 212 into the secondary treatment compartment 230 at 324.

Returning again to FIG. 2, the secondary media bed 232 is supported in the secondary treatment compartment 230 above an outflow area 234 of the secondary treatment compartment 230. In particular, the overflow from the primary treatment compartment 220 is directed with gravity through the secondary media bed to the outflow area 234. The secondary treatment compartment 230, and in particular the outflow area 234 is fluidly coupled to the outlet 206 to output treated water from the water treatment apparatus 200.

As can be seen in FIG. 3, after water is directed over the top edge 213 of the separating wall 212 into the secondary treatment compartment 230 at 324, the water is directed through the secondary media bed 232 at 328 to the outflow area 234, The treated water in the outflow area 234 is directed at 332 out of the water treatment apparatus 200 via the outlet 206.

In some applications, such as in dental applications, the water treatment apparatus 200 may also intake air in addition to the water to be treated. For example, dental suction devices may be used to draw dental wastewater during a dental procedure, and by nature of the suction, may also draw air. In particular, the dental suction devices may evacuate directly into the water treatment apparatus 200, and accordingly, the water treatment apparatus 200 may intake air or gases in addition to the water. Accordingly, the water treatment apparatus 200 may further be configured to manage the air and/or gases received with the water.

For example, returning to FIG. 2, the water treatment apparatus 200 may include a separation chamber 250, a gas line 252, one or more vents 254, and a pump 256 to manage the air and/or gases received with the water.

The separation chamber 250 may be defined by the housing 202 and the conduit 240. In particular, the conduit 240 may be situated within the housing 202 to define a large enough separation chamber 250 to allow the gases and the water to naturally separate in the volume of the separation chamber 250 based on their respective fluid properties. In some examples, the housing 202 may include a dome to improve the airflow within the separation chamber 250.

The gas line 252 is configured to direct the gases to an outlet 253. In particular, the gas line 252 may be coupled to the vents 254, which are configured to allow venting of gases from regions of the water treatment apparatus 200. In some examples, the gas line 252 may not include a physical structure along all sections of the gas line. For example, the gas line 252 may include pipes to allow air to pass through other structures of the water treatment apparatus 200. Air may otherwise freely flow in the space within the water treatment apparatus 200. In particular, the presently illustrated water treatment apparatus 200 includes one vent 254 in the separation chamber 250 to allow venting of gases from the separation chamber 250, and one vent 254 along the conduit 240 to allow venting of gases from within the conduit 240. The vents 254, and in particular, the vent 254 along the conduit 240, may include valves or traps to restrict water from escaping the conduit, while allowing gases to be vented.

The pump 256 is coupled to the gas line 252 to actively draw the air and/or gases through the gas line to the outlet 253. In some examples, the outlet 253 may be coupled with the outlet 206 to re-introduce the air into the treated water. The water treatment apparatus 200 is thus provided with a ventilation system to alleviate pressure buildup and promote the movement of fluids through the water treatment apparatus.

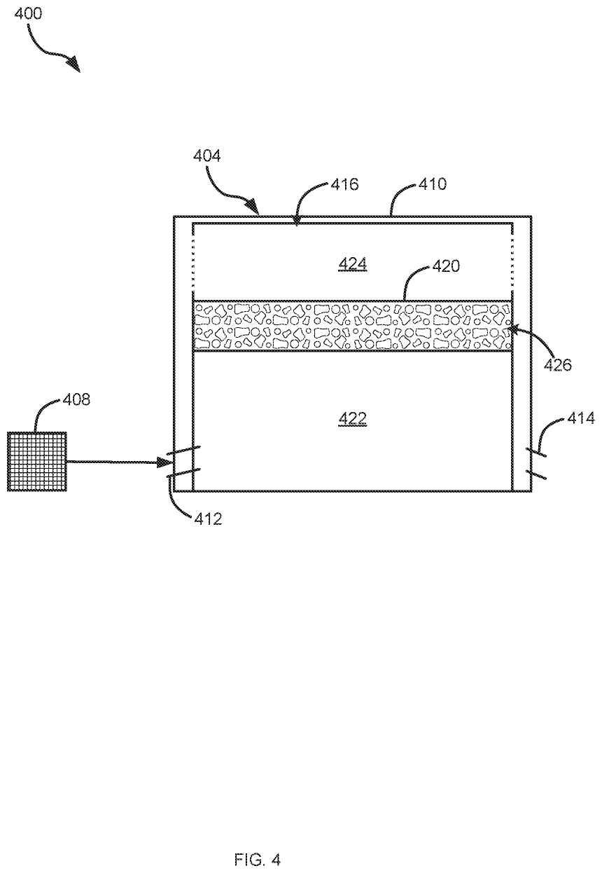

FIG. 4 depicts an example water treatment system 400 for treating water containing a contaminant. The water treatment system 400 includes a water treatment apparatus 404 and may further include a pre-filter 408. The water treatment system 400 will be described in conjunction with removing mercury from a water stream; in other examples, alternate or additional contaminants to be removed from a water stream are also contemplated.

The water treatment apparatus 404 includes a housing 410 and a media bed 420. The housing 410 includes an inlet 412 to receive water to be treated and an outlet 414 to output treated water. The housing 410 defines an enclosed treatment space 416 for treating water and preferably is impermeable to vapors and liquids.

The media bed 420 extends across the treatment space 416 of the housing 410 to divide the treatment space 416 into a collection area 422 and an outflow area 424. The media bed 420 contains a ion exchange media 426 to separate the mercury, and in particular, soluble mercury from the water. The ion exchange media 426 may be a micro-porous material impervious to water, such as activated coconut carbon. In particular, the ion exchange media 426 is micro-porous to accept and retain a large number of mercury particles. Further, the ion exchange media 426 is impervious or substantially impervious to water to reduce the amount of water-based erosion and degradation of the ion exchange media 426. That is, the stability of the ion exchange media 426 in water extends the longevity of the water treatment system 400 and improves the retention of the mercury in the ion exchange media 426.

For example, the ion exchange media 426 may comprise activated coconut carbon to separate the soluble mercury from the water via ion exchange. In particular, as described above, coconut carbon is micro-porous and activation, for example by steam, also serves to enhance the adsorption properties of the coconut carbon. Additionally, activated coconut carbon is ionized so as to attract and retain soluble mercury in its pores. Activated coconut carbon is also substantially impervious to water, and hence does not erode or degrade to release the mercury held therein. The water treatment apparatus 404 may be configured to contain between about 3 to 20 ounces of activated coconut carbon in the media bed 420. In other examples, the water treatment apparatus 404 may contain up to about 2 to 3 pounds of activated coconut carbon.

The collection area 422 is fluidly coupled to the inlet 412 to receive water from the inlet 412. In particular, the inlet 412 may be located on the housing 410 to feed directly into the collection area 422. In some examples, the inlet 412 may include a one-way valve to prevent backflow of water from the collection area 422 out of the inlet 412. The outflow area 424 is fluidly coupled to the outlet 414 to output treated water from the outlet 414. In the present example, water from the outflow area 424 flows outside the treatment space 416 to the outlet. In other examples, the outlet 414 may be located on the housing 410 to be fed directly from the outflow area 424. Further, the collection area 422 and the outflow area 424 are located such that water in the collection area 422 is directed against gravity through the media bed 420 to the outflow area 424 to produce the treated water. That is, the collection area 422 is to receive and collect water until overflow of the water in the collection area 422 is directed against gravity through the media bed 420 to produce treated water.

The flow of the water from the collection area 422 against gravity through the media bed 420 to the outflow area 424 serves to extend the ion exchange period of the water in the media bed 420. In particular, in comparison to a gravity filter, the rate of descent of water through a media bed is based at least partially on gravity. In contrast, in the present water treatment apparatus 404, the rate of movement of the water through the media bed 420 is based on the rate of accumulation of water in the collection area 422 causing the water level in the collection area 422 to overflow through the media bed 420. In typical applications, the rate of inflow of water to the water treatment apparatus 404 will result in a slower rate of accumulation of water relative to the rate of descent of water in a gravity filter, and hence a longer ion exchange period. As noted previously, the longer ion exchange period enhances the efficacy of the ion exchange media 426 to separate the soluble mercury from the water.

In other examples, other water treatment apparatuses, such as the water treatment apparatus 100 or the water treatment apparatus 200 are contemplated for use in the system 400.

Preferably, the water treatment system 400 includes the pre-filter 408 located upstream of the water treatment apparatus 404. The pre-filter 408 is configured to separate solid materials from the water prior to the water entering the water treatment apparatus 404. Thus, the water received at the water treatment apparatus 404 may be substantially free of solid materials. The pre-filter 408 may be a mesh or a screen or the like. In other examples, the pre-filter 408 may be similar to an inverted version of the water treatment apparatus 404. That is, water may enter an inlet, pass through one or more meshes or screens or the like to separate solid material from the water, and be directed back up against gravity outside the treatment space to an outlet.

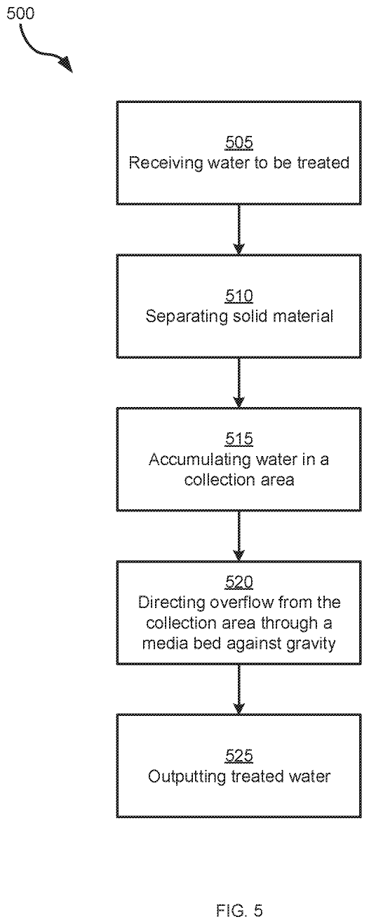

Referring now to FIG. 5, a flowchart depicting an example method 500 of treating water is depicted. The method 500 may be performed by the water treatment apparatus 100, the water treatment apparatus 200, the water treatment system 400, or other suitable water treatment systems or apparatuses. Some of the blocks of the method 500 may, in some examples, be performed simultaneously, or in a different order than depicted, and hence are referred to as blocks and not steps.

At block 505, water containing a contaminant is received at a water treatment system including a water treatment apparatus.

At block 510, solid materials are separated from the water. The solid materials may be separated from the water using a pre-filter, such as a mesh or a screen, upstream of the water treatment apparatus, or in a settling or sedimentation chamber of the water treatment apparatus. In some examples, the water treatment system may include both a pre-filter upstream of the water treatment apparatus and a settling chamber within the water treatment apparatus to promote the removal of solid materials from the water.

At block 515, the water is accumulated in a collection area of the water treatment apparatus. In particular, water may be directed from an inlet of the water treatment apparatus to the collection area. Further, the collection area may serve as the settling or sedimentation chamber for removing solid materials at block 510.

At block 520, overflow of water from the collection area is directed through a media bed against gravity to permit an ion exchange to separate the contaminant from the water. The flow of the water from the collection area against gravity through the media bed serves to extend the ion exchange period of the water in the media bed. In particular, in comparison to a gravity filter, where the rate of descent of water through the media bed is based at least partially on gravity, in the presently described method, the rate of movement of the water through the media bed is based on the rate of accumulation of water in the collection area. That is, water accumulating in the collection area causes the water level in the collection area to overflow through the media bed. In typical applications, the rate of inflow of water to the water treatment apparatus will result in a slower rate of accumulation of water relative to the rate of descent of water in a gravity filter, and hence a longer ion exchange period. As noted previously, the longer ion exchange period enhances the efficacy of the ion exchange media to separate the contaminant from the water.

At block 525, the treated water is output. In some examples, prior to being output, the water may be treated in further treatment steps.

As described above, improved water treatment apparatuses, systems and methods are provided. The water treatment apparatus increases efficacy of the water treatment by increasing the ion exchange period of water in a ion exchange media. This is achieved by directing water from a collection area against gravity through a media bed so that the ion exchange period is based on the rate of accumulation of water, rather than being influenced by the force of gravity. Further, multiple treatment compartments may be employed to allow multiple treatment steps of the treatment process. Some systems may include a system, such as a pre-filter or a settling chamber, to remove solid materials from the water prior to or during the treatment process.

Such example water treatment apparatus may be particularly suited to dental applications to separate soluble mercury and amalgam from dental water streams prior to discharge into public sewer systems. In particular, the water treatment apparatuses may employ activated coconut carbon, which is particularly suited to attract and retain soluble mercury based on its ionization and micro-porosity during the ion exchange process. Activated coconut carbon is also substantially impervious to water so that it does not erode or degrade, and therefore increases the longevity of the water treatment apparatus and retention of the mercury in the media bed.

The scope of the claims should not be limited by the embodiments set forth in the above examples, but should be given the broadest interpretation consistent with the description as a whole.

1. A water treatment apparatus comprising:
a housing having an inlet to receive water containing a contaminant;
a primary treatment compartment within the housing, the primary treatment compartment including a primary media bed containing a ion exchange media to separate the contaminant from the water, the primary media bed supported above a collection area of the primary treatment compartment; and
a conduit to direct flow of the water to the collection area; and
wherein overflow of the water in the collection area is directed against gravity through the primary media bed to produce treated water.

2. The water treatment apparatus of claim 1, further comprising a secondary treatment compartment within the housing, the secondary treatment compartment to receive the overflow from the primary treatment compartment, the secondary treatment compartment including a secondary media bed containing a further ion exchange media to separate the contaminant from the water.

3. The water treatment apparatus of claim 2, further comprising a separating wall to separate the primary treatment compartment from the secondary treatment compartment.

4. The water treatment apparatus of claim 3, wherein the overflow from the primary treatment compartment is directed over a top edge of the separating wall into the secondary treatment compartment.

5. The water treatment apparatus of claim 1, wherein the ion exchange media comprises a micro-porous material impervious to water.

6. The water treatment apparatus of claim 1, wherein the ion exchange media comprises activated coconut carbon.

7. The water treatment apparatus of claim 1, wherein the contaminant comprises soluble mercury.

8. A water treatment apparatus comprising:
a housing having an inlet to receive water containing a contaminant, the housing having a treatment space;
a separating wall extending from a floor of the housing to divide the treatment space into a primary treatment compartment and a secondary treatment compartment;
a primary media bed containing a ion exchange media to separate the contaminant from the water in the primary treatment compartment; and
a secondary media bed containing a further ion exchange media to separate the contaminant from the water in the secondary treatment compartment.

9. The water treatment apparatus of claim 8, wherein partially treated water from the primary treatment compartment is directed to the secondary treatment compartment for further treatment.

10. The water treatment apparatus of claim 8, wherein the primary media bed is supported in the primary treatment compartment above a collection area of the primary treatment compartment.

11. The water treatment apparatus of claim 10, further comprising a conduit to direct flow of the water from the inlet with gravity to the collection area.

12. The water treatment apparatus of claim 11, wherein overflow of the water in the collection area of the primary treatment compartment is directed against gravity through the primary media bed.

13. The water treatment apparatus of claim 12, wherein the overflow from the primary treatment compartment is directed over a top edge of the separating wall into the secondary treatment compartment.

14. The water treatment apparatus of claim 13, wherein the secondary media bed is supported in the secondary treatment compartment above an outflow area of the secondary treatment compartment, and wherein the overflow from the primary treatment compartment is directed with gravity through the secondary media bed to the outflow area of the secondary treatment compartment.

15. The water treatment apparatus of claim 8, wherein at least one of the ion exchange media and the further ion exchange media comprises a micro-porous material impervious to water.

16. The water treatment apparatus of claim 8, wherein at least one of the ion exchange media and the further ion exchange media comprises activated coconut carbon.

17. The water treatment apparatus of claim 8, further comprising:
a separation chamber configured to separate gases from the water;
a gas line coupled to the separation chamber, the gas line configured to direct the gases to an outlet; and
a pump coupled to the gas line to drive the gases from the separation chamber, through the gas line to the outlet.

18. A water treatment system for treating water containing soluble mercury, the water treatment system comprising:
a water treatment apparatus comprising:
a housing having an inlet to receive the water; and
a media bed disposed in the housing, the media bed extending across a treatment space of the housing to divide the treatment space into a collection area and an outflow area and containing a ion exchange media to separate the soluble mercury from the water to produce treated water, wherein the collection area is fluidly coupled to the inlet to receive the water from the inlet; and wherein the water in the collection area is directed against gravity through the media bed to the outflow area to produce the treated water.

19. The water treatment system of claim 18, further comprising a pre-filter located upstream of the water treatment apparatus, the pre-filter to separate solid materials from the water.

20. The water treatment system of claim 18, wherein the ion exchange media comprises activated coconut carbon.
